(19) United States
(12) Patent Application Publication
(10) Pub. No.: US 2012/0219305 A1
(43) Pub. Date: Aug. 30, 2012

(54) DEVELOPMENT UNIT DETERMINING METHOD AND IMAGE FORMING DEVICE

(75) Inventor: Xue Fei, Shanghai (CN)

(73) Assignee: Ricoh Company, Ltd., Tokyo (JP)

(21) Appl. No.: 13/366,449

(22) Filed: Feb. 6, 2012

(30) Foreign Application Priority Data
Feb. 28, 2011 (CN) 201110059263.6

(51) Int. Cl. G03G 15/08

(52) U.S. Cl. 399/12; 399/27

(57) ABSTRACT

Disclosed are a method of determining whether a development unit is refilled with developer and an image forming device adopting the method. The method comprises a first step of reading a serial number and an amount of remaining developer from the development unit, and determining whether the amount of the remaining developer read from the development unit is greater than 0; and a second step of determining, in a case where the determination result of the first step is “YES”, that the development unit is not refilled with the developer; or determining, in a case where the determination result of the first step is “NO”, whether the development unit is refilled with the developer, based on information stored in the development unit.

### BACKGROUND OF THE INVENTION

1. Field of the Invention

The present invention relates to a method of determining whether a development unit has been refilled with developer (i.e. new developer) and an image forming device in which the method is utilized.

2. Description of the Related Art

In a conventional image forming device, there is a detachable development unit in general. In the development unit, there is developer such as toner, etc.

When a development unit filled with developer is shipped to market, a serial number of the development unit and an amount of the developer are usually stored in the development unit. After the development unit is installed in an image forming device, the image forming device may, in a process of carrying out image processing, detect the amount of remaining developer in the development unit, and uninterruptedly update the amount of the remaining developer in the development unit at the same time.

In conventional techniques, the amount of remaining developer in a development unit is usually detected by using a mechanical method.

For example, as shown in FIG. 1, a unit for detecting the amount of remaining developer (hereinafter called “remaining developer amount detecting unit”) is disposed in an image forming device. The remaining developer amount detecting unit includes a photoelectric sensor, a rocker arm, and a swing arm. The remaining developer is inside a development unit. A mixer rotates so as to cause the remaining developer to move to a remaining developer detecting area. The swing arm is located at the center of the remaining developer detecting area. The rocker arm is connected to the swing arm. The swing arm rotates so that the rocker arm may behave correspondingly. In a case where there is relatively much remaining developer in the development unit, since a resistance force of the remaining developer is relatively big, the swing arm and the rocker arm carry out a relatively slight movement. As the remaining developer is continuously consumed, the resistance force of the remaining developer becomes small; as a result, the movement of the swing arm and the rocker arm becomes relatively dramatic.

A basic principle of the remaining developer amount detecting unit detecting the amount of the remaining developer in the development unit is as follows. The photoelectric sensor sends a photoelectric signal. After the remaining developer is consumed in some measure, the rocker arm connected to the swing arm may move to a position where the photoelectric signal sent by the photoelectric sensor may be reflected by the rocker arm. At the same time, the rocker arm receives the photoelectric signal, and feeds a feedback signal back to the photoelectric sensor. Based on the feedback signal, it is determined whether the remaining developer in the development unit is running out.

At present, in order to decrease cost of the whole image forming device, there is a need not to adopt the above mentioned remaining developer amount detecting unit to detect the amount of the remaining developer in the development unit. In the conventional techniques, in a process of carrying out image processing, the amount of the remaining developer in the development unit is usually calculated by subtracting a consumed amount of the remaining developer in the process from the amount of the remaining developer in the development just before the process. However, in a case where the remaining developer amount detecting unit is not installed in the image forming device after the remaining developer runs out, and the development unit has been refilled with new developer, since the remaining developer in the development unit before the refill has run out, at this time, the amount of the new developer in the development unit is expressed as “0”. In other words, after the development unit is refilled with the new developer, a value of the amount of the new developer in the development unit cannot be reset; that is, a value of the amount of the remaining developer in the development before the refill cannot be modified. In the conventional techniques, if this kind of development unit is installed in the image forming device, then the development unit will be determined as a development unit having no developer. That is, in the conventional techniques, a development unit refilled with new developer is not able to be normally utilized in an image forming device.

### SUMMARY OF THE INVENTION

The aim of the present invention is to propose a method able to correctly determine whether a development unit has been refilled with new developer and an image forming device in which the method is utilized in order to overcome the above described disadvantages of the prior art.

According to one aspect of the present invention, a method of determining whether a development unit has been refilled with developer is provided. The development unit is installed in an image forming device. A serial number of the development unit and an amount of remaining developer are stored in the development unit. The method comprises a first step of reading, at a time when a power supply is switched from turn-off to turn-on in a state where a cover of the image forming device is closed or when the cover of the image forming device is switched from open to closed in a state where the power supply is turned on, the serial number and the amount of the remaining developer from the development unit, and determining whether the amount of the remaining developer read from the development unit is greater than 0; and a second step of determining, in a case where the determination result of the first step is “YES”, that the development unit is not refilled with the developer, i.e., the development unit has the remaining developer, and may be used for image forming processing, and then storing the serial number read from the development unit in the image forming device, or determining, in a case where the determination result of the first step is “NO”, whether the development unit is refilled with the developer, based on information stored in the development unit.

According to another aspect of the present invention, an image forming device is provided in which the method of determining whether a development unit has been refilled with developer is utilized, is provided.

The above described method of determining whether a development unit has been refilled with developer and the image forming device may correctly determine, without a dedicated detection unit installed in the image forming device, whether a development unit currently installed in the image forming device is refilled with new developer. As a result, it is possible to ensure that the development unit refilled with the new developer may be normally utilized in the image forming device.

### BRIEF DESCRIPTION OF THE DRAWINGS

FIG. 1 illustrates a structure of a conventional unit for detecting an amount of remaining developer in a development unit;

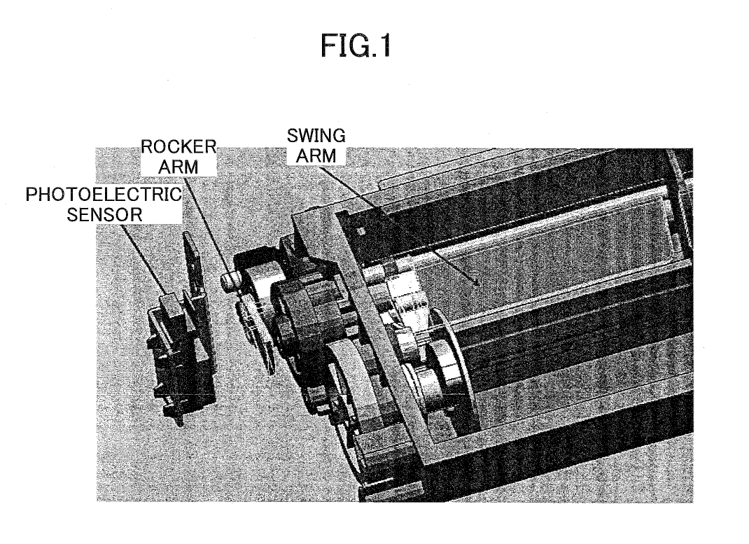

FIG. 2 is a processing flowchart of a method of determining whether a development unit has been refilled with developer, according to an embodiment of the present invention;

FIG. 3 is a processing flowchart of a step of determining based on information stored in a development unit whether the development unit is refilled with developer, according to a first embodiment of the present invention; and

FIG. 4 is a processing flowchart of a step of determining based on information stored in a development unit whether the development unit is refilled with developer, according to a second embodiment of the present invention.

### DETAILED DESCRIPTION OF THE PREFERRED EMBODIMENTS

Hereinafter, various embodiments of the present invention will be concretely described with reference to the drawings. However it should be noted that the same symbols, which are in the specification and the drawings, stand for constructional elements having the basically-same function and structure, and repeated explanations for the constructional elements are omitted.

In addition, it should be noted that in the following embodiments of the present invention, a development unit is installed in an image forming device, and a serial number of the development unit and amount of remaining developer are stored in the development unit.

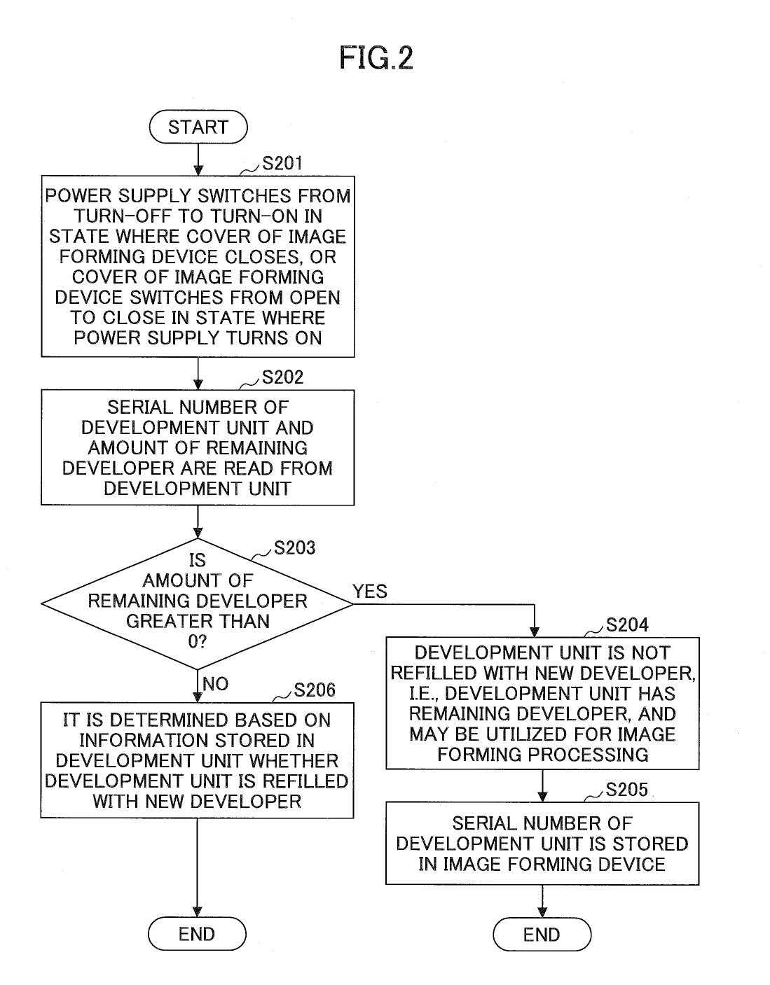

FIG. 2 is a forming flowchart of a method of determining whether a development unit is refilled with developer (i.e. new developer), according to an embodiment of the present invention.

The method of determining whether a development unit is refilled with new developer in this embodiment includes the following steps.

At a time when a power supply is switched from turn-off to turn-on in a state where a cover of the image forming unit is closed or when the cover of the image forming unit is switched from open to closed in a state where the power supply is turned on (STEP S201), the serial number of the development unit and the amount of the remaining developer are read from the development unit (STEP S202). Next it is determined whether the amount of the remaining developer read from the development unit is greater than 0 (STEP S203).

In a case where the determination result of STEP S203 is “YES”, it is determined that the development unit is not refilled with new developer, i.e., the development unit still has the remaining developer, and may be used for image forming processing (STEP S204); and then the serial number read from the development unit is stored in the image forming device (STEP S205).

In a case where the determination result of STEP S203 is “NO”, it is determined based on information stored in the development unit whether the development unit is refilled with new developer (STEP S206).

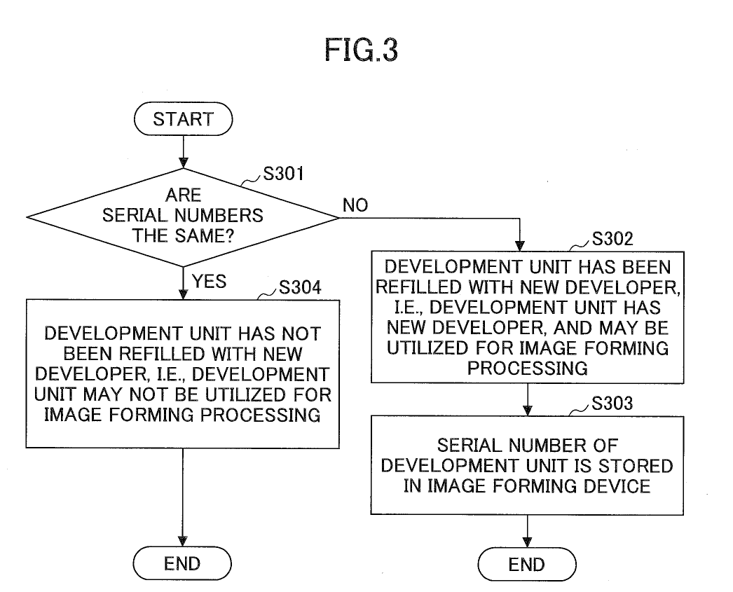

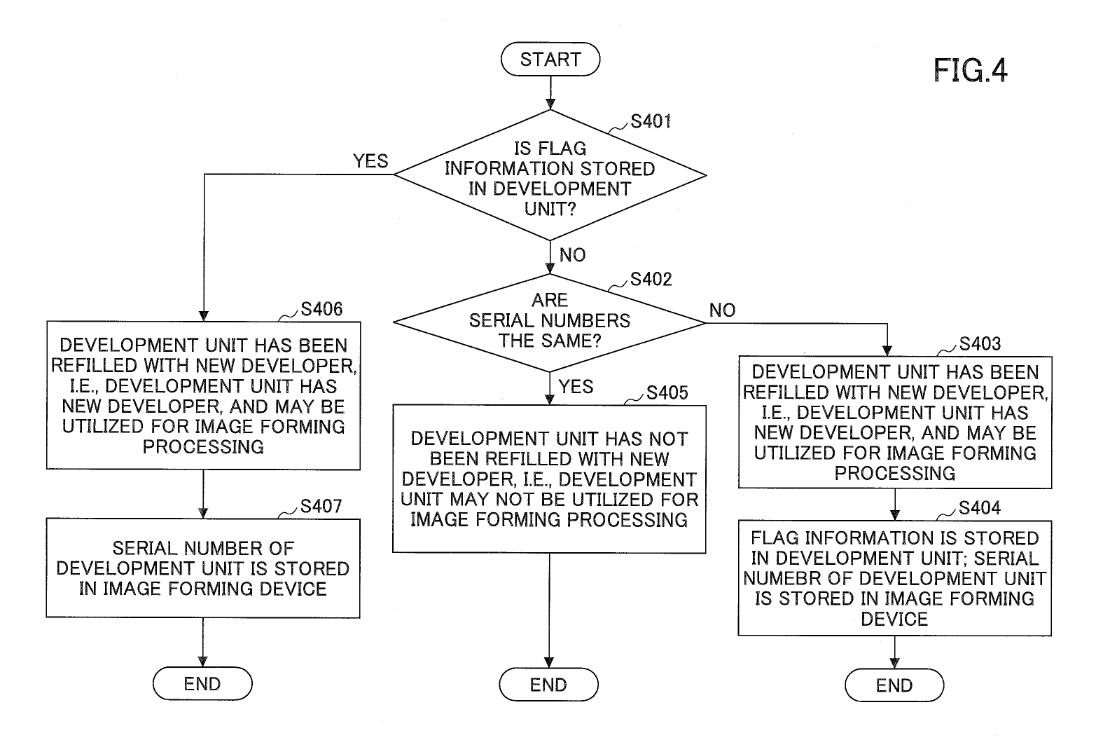

In what follows, the above mentioned STEP 206, i.e., a step of determining based on the information stored in the development unit whether the development unit is refilled with the new developer, is concretely described based on FIGS. 3 and 4.

FIG. 3 is a processing flowchart of the step of determining based on the information stored in the development unit whether the development unit is refilled with the new developer, according to a first embodiment of the present invention.

Here it should be noted that in the first embodiment of the present invention, a one-time-use (i.e. used only once in the image forming device) serial number of the development unit is stored in the image forming device.

In this embodiment, the step S206, of determining based on the information stored in the development unit whether the development unit is refilled with the new developer, includes the following steps.

It is determined whether the serial number read from the development unit is the same as the one-time-use serial number stored in the image forming device (STEP S301).

In a case where the determination result of the STEP S301 is “NO”, i.e., the two serial numbers are different, it is determined that the development unit has been refilled with the new developer, i.e., the development unit has the new developer, and may be utilized in the image forming device (STEP S302); and then the serial number read from the development unit is stored in the image forming device to serve as the one-time-use serial number (STEP S303).

In a case where the determination result of the STEP S301 is “YES”, i.e., the two serial numbers are the same, it is determined that the development unit has not been refilled with the new developer, i.e., the development unit may not be utilized in the image forming device (STEP S304).

According to the method of determining whether the development unit is refilled with the new developer, in the first embodiment of the present invention, it is possible to correctly determine, without a dedicated detection unit disposed in the image forming device, whether a development unit currently installed in an image forming device is refilled with new developer. As a result, it is possible to guarantee that the development unit refilled with the new developer may be normally used in the image forming device.

FIG. 4 is a processing flowchart of the step S206 of determining based on the information stored in the development unit whether the development unit is refilled with the new developer, according to a second embodiment of the present invention.

Here it should be noted that in the second embodiment of the present invention, a one-time-use (i.e. used only once in the image forming device) serial number of the development unit is stored in the image forming device.

In this embodiment, the step S206, of determining based on the information stored in the development unit whether the development unit is refilled with the new developer, includes the following steps.

It is determined whether flag information is stored in the development unit (STEP S401); the flag information indicates that the development unit has been refilled with the new developer.

In a case where the determination result of STEP S401 is “NO”, it is determined whether the serial number read from the development unit is the same with the one-time-use serial number stored in the image forming device (STEP S402).

In a case where the determination result of STEP S402 is “NO”, i.e., the two serial numbers are different, it is determined that the development unit has been refilled with the new developer, i.e., the development unit has the new developer, and may be utilized for image forming processing (STEP S403), then the flag information is stored in the development unit, and then the serial number read from the development unit is stored in the image forming device to serve as the one-time-use serial number (STEP S404).

In a case where the determination result of STEP S402 is “YES”, i.e., the two serial numbers are the same, it is determined that the development unit has not been refilled with the new developer, i.e., the development unit may not be utilized for image forming processing at this time (STEP S405).

In a case where the determination result of STEP S401 is “YES”, it is determined that the development unit has been refilled with the new developer, i.e., the development unit has the new developer, and may be utilized for image forming processing (STEP S406), and then the serial number read from the development unit is stored in the image forming device to serve as the one-time-use serial number (STEP S407).

The above described second embodiment is based on the above described first embodiment. By setting the flag information, it is possible to render the determination of whether the development unit is refilled with the new developer easier.

Furthermore there is an image forming device, in which any one of the above mentioned methods according to the above described embodiments is provided; the image forming device may achieve the technical effect of the corresponding embodiment.

In addition, it should be noted that the development unit, whose refilling is determined by any one of the above mentioned methods according to the above described embodiments, refers to a development unit which is normally filled with developer by a formal organization, and does not include a development unit filled with developer by a user or abnormally filled with developer.

While the present invention is described with reference to the specific embodiments chosen for purpose of illustration, it should be apparent that the present invention is not limited to these embodiments, but numerous modifications could be made thereto by those people skilled in the art without departing from the basic concept and technical scope of the present invention.

The present application is based on Chinese Priority Patent Application No. 201110059263.6 filed on Feb. 28, 2011, the entire contents of which are hereby incorporated by reference.

What is claimed is:

1. A method of determining whether a development unit is refilled with developer, wherein, the development unit is installed in an image forming device, and a serial number of the development unit and an amount of remaining developer are stored in the development unit, the method comprising:
a first step of reading, at a time when a power supply is switched from turn-off to turn-on in a state where a cover of the image forming device is closed or when the cover of the image forming device is switched from open to closed in a state where the power supply is turned on, the serial number and the amount of the remaining developer from the development unit, and determining whether the amount of the remaining developer read from the development unit is greater than 0; and
a second step of determining, in a case where the determination result of the first step is “YES”, that the development unit is not refilled with the developer, i.e., the development unit has the remaining developer, and may be utilized for image forming processing, and then storing the serial number read from the development unit in the image forming device, or determining, in a case where the determination result of the first step is “NO”, whether the development unit is refilled with the developer, based on information stored in the development unit.

2. The method according to claim 1, wherein:
a one-time-use serial number of the development unit is stored in the image forming device, and
in the second step, the determination of whether the development unit is refilled with the developer, based on the information stored in the development unit is carried out by determining whether the serial number read from the development unit is the same as the one-time-use serial number stored in the image forming device, wherein,
in a case where the two serial numbers are different, it is determined that the development unit has been refilled with the developer, i.e., the development unit has the developer, and may be utilized for image forming processing, and then the serial number read from the development unit is stored in the image forming device; and
in a case where the two serial numbers are the same, it is determined that the development unit has not been refilled with the developer, i.e., the development unit may not be utilized for image forming processing.

3. The method according to claim 1, wherein:
a one-time-use serial number of the development unit is stored in the image forming device;
and in the second step, the determination of whether the development unit is refilled with the developer, based on the information stored in the development unit is carried out by
(a) determining whether flag information is stored in the development unit, wherein, the flag information is one indicating that the development unit has been refilled with the developer;
(b) in a case where the determination result of the step (a) is “NO”, it is determined whether the serial number read from the development unit is the same with the one-time-use serial number stored in the image forming device, wherein,
in a case where the two serial numbers are different, it is determined that the development unit has been refilled with the developer, i.e., the development unit has the developer, and may be utilized for image forming processing, then the flag information is stored in the development unit, and then the serial number read from the development unit is stored in the image forming device, and
in a case where the two serial numbers are the same, it is determined that the development unit has not been refilled with the developer, i.e., the development unit may not be utilized for image forming processing; and
(c) in a case where the determination result of the step (a) is “YES”, it is determined that the development unit has been refilled with the developer, i.e., the development unit has the developer, and may be utilized for image forming processing, and then the serial number read from the development unit is stored in the image forming device.

4. An image forming device in which the method according to claim 1 is utilized.
